(19) United States
(12) Patent Application Publication
(10) Pub. No.: US 2005/0147032 A1
(43) Pub. Date: Jul. 7, 2005

(54) Apportionment of traffic management functions between devices in packet-based communication networks

(76) Inventors: Norman Allan Lyon, Gatineau (CA); Scott Linn Mason, Ottawa (CA)

Correspondence Address: SMART AND BIGGAR, 438 UNIVERSITY AVENUE, SUITE 1500 BOX 111, TORONTO, ON, M5G2K8, CA

(21) Appl. No.: 10/787,945

(22) Filed: Feb. 27, 2004

Related U.S. Application Data
(60) Provisional application No. 60/530,889, filed on Dec. 22, 2003.

(51) Int. Cl. H04J 1/16

(52) U.S. Cl. 370/229

(57) ABSTRACT

In a packet-based network node, traffic management functions are apportioned between an upstream device and a connected queuing device. The upstream device is responsible for receiving packets and optionally discarding them. The queuing device is responsible for enqueuing undiscarded packets into queues pending transmission, computing the congestion states of the queues, and communicating the congestion states to the upstream device. The upstream device bases its optional discarding on these computed congestion states and, optionally, on discard probabilities and an aggregate congestion level, which may also be computed by the queuing device. The upstream device may additionally mark packets as having experienced congestion based on congestion indication states, which may further be computed by the queuing device. Any statistics maintained by the upstream device may reflect packets discarded for any reason (e.g. at both OSI layers 2 and 3).

### CROSS REFERENCE TO RELATED APPLICATIONS

The present application claims the benefit of prior provisional application Ser. No. 60/530,889 filed Dec. 22, 2003.

### FIELD OF THE INVENTION

The present invention relates to packet-based communications networks, and more particularly to traffic management functions performed in packet-based communications networks.

### BACKGROUND OF THE INVENTION

In a packet-based communications network, packets are transmitted between nodes (e.g. switches or routers) interconnected by links (e.g. physical or logical interconnections comprising optical fibres). The term “packet” as used herein is understood to refer to any fixed or variable size grouping of bits, i.e. a Protocol Data Unit. Examples of packet-based networks include Asynchronous Transfer Mode (ATM) networks in which packets correspond to cells, and Frame Relay networks in which packets correspond to frames.

A key issue in packet-based networks is traffic management. Each node in a packet-based network has a set of queues for storing packets to be switched or routed to a next node. The queues have a finite capacity. When the number of packets being transmitted through a network node approaches or exceeds the queue capacity at the node, congestion occurs. Traffic management refers to the actions taken by the network to avoid congestion.

Various techniques for handling congestion are known. For example, a feedback approach referred to generally as “congestion indication” may be employed in which the congestion state of a flow (associated with the International Organization for Standarization (ISO) Open Systems Interconnection (OSI) Reference Model, layer 3), or of a connection (associated with the OSI layer 2) in a network (e.g. a virtual connection such as an ATM Virtual Channel Connection (VCC)), is measured and marked as packets are transmitted from a source node to a destination node. An indication of the measured congestion state is then sent back from the destination node to the source node, in which an indicator is set in a packet travelling from the destination node back to the source node to indicate congestion. If the indicator indicates that congestion has been experienced along the path from the source to the destination node, the source node may address the problem by reducing its rate of packet transmission.

In another approach, a scheme such as Random Early Detection (RED) may be employed whereby a destination node experiencing congestion intentionally discards a small percentage of packets in order to effectively communicate to a source node that congestion is being experienced. The desired effect of slowing the source node packet transmission rate is achieved when a protocol at the source node (e.g. the Transmission Control Protocol (TCP)) interprets the lost packets as being indicative of congestion. This approach may be thought of as a congestion indication approach in which congestion marking is implicit in the loss of packets. RED was originally described in Floyd, S and Jacobson, V., Random Early Detection gateways for congestion avoidance, IEEE/ACM Transactions on Networking, V. 1 N. 4, August 1993, pp. 397-413.

Other approaches for handling congestion may involve the discarding of packets of lesser priority by a node experiencing congestion.

It is typical for traffic management functions at a particular network node to be performed by a single device, i.e. an integrated circuit, such as an Application Specific Integrated Circuit (ASIC), which forms part of the network node. Such a device is typically responsible for a broad range of packet switching and/or routing functions, such as: receiving packets; storing packets in queues; scheduling packets for transmission to a subsequent node; terminating a protocol for an inbound packet; address matching; and so forth. In performing these functions, the device may process protocols at various layers of the ISO OSI Reference Model, including the network layer (OSI layer 3) and the data link layer (OSI layer 2). Such a traffic management device may further be responsible for compiling performance metrics, i.e. traffic statistics, at both of these layers. For example, in the case where the Internet Protocol (IP) is employed at layer 3 and ATM is employed at layer 2, the device may be responsible for tracking a layer 3 statistic comprising a number of packets discarded per IP flow as well as a layer 2 statistic comprising a number of packets discarded per ATM VCC. This and other similar types of traffic statistics may be necessary for purposes of determining a carrier's compliance with a Service Level Agreement, which may obligate a carrier to provide a certain bandwidth, loss rate, and quality of service to a customer.

A possible disadvantage of using a single traffic management device as described, however, is that the device may become overloaded due to the broad range of functions it is obligated to perform. Performance may suffer as a result.

Another approach referred to as discrete layer 3 and layer 2 processing involves the apportionment of traffic management functions between two devices. In discrete layer 3 and layer 2 processing, an upstream device and a downstream device are responsible for processing packets at OSI layer 3 and OSI layer 2 respectively. For example, the upstream device may process IP packets while the downstream processes ATM packets (i.e. ATM cells). Each device maintains statistics for its respective layer only.

In this architecture, the layer 3 upstream device is empowered to discard packets independent of the layer 2 state. The processing at the upstream device typically includes an enqueue process and a dequeue process. The enqueue process may entail optionally classifying packets to apply access control filtering and/or policing, classifying packets to identify traffic management attributes including emission priority and loss priority, performing buffer management checks, performing network congestion control checks, discarding packets if necessary, enqueuing undiscarded packets, and updating statistics. The dequeue process may entail running a scheduler to determine a queue to serve, updating statistics, dequeuing packets, and segmenting packets into cells. When the upstream device has completed its processing of a packet, it passes the packet to the downstream device for further processing at layer 2. Processing at the downstream device also typically includes an enqueue process and a dequeue process. The enqueue process may entail examining headers (connection, cell loss priority, cell type, etc.), retrieving connection context (destination queue, connection discard state, etc.), determining whether to discard a cell based on congestion or discard state, enqueuing undiscarded cells, and updating statistics as appropriate. The dequeue process may entail running a scheduler to determine a queue to serve, determining a congestion level of a queue, updating statistics and dequeuing cells. Layer 2 processing includes an examination of the congestion state of the queue into which the packet should be stored pending its transmission to another network node. If the examination indicates that the queue is congested, the packet may be discarded in an effort to alleviate congestion.

A usual disadvantage of discrete layer 3 and layer 2 processing is the lack of any notification by the downstream device to the upstream device of any discards performed at the downstream device. As a result, any layer 3 statistics compiled by the upstream device (e.g. packets discarded per IP flow) will not account for any packets discarded by the downstream device at layer 2.

Another problem with discrete layer 3 and layer 2 processing is the possibility that the upstream device may perform layer 3 traffic management processing for packets which are later discarded by the downstream device in accordance with layer 2 traffic management processing. Such cases are wasteful of processing bandwidth of the upstream device.

### SUMMARY OF THE INVENTION

In a packet-based network node, traffic management functions are apportioned between an upstream device and a connected queuing device. The upstream device is responsible for receiving packets and optionally discarding them. The queuing device is responsible for enqueuing undiscarded packets into queues pending transmission, computing the congestion states of the queues, and communicating the congestion states to the upstream device. The upstream device bases its optional discarding on these computed congestion states and, optionally, on discard probabilities and an aggregate congestion level, which may also be computed by the queuing device. The upstream device may additionally mark packets as having experienced congestion based on congestion indication states, which may further be computed by the queuing device. Any statistics maintained by the upstream device may reflect packets discarded for any reason (e.g. at both OSI layers 2 and 3).

In accordance with an aspect of the present invention there is provided a method of managing traffic in a packet-based network, comprising: at an upstream device: receiving packets; for a received packet: identifying a queue of a separate queuing device into which said packet is enqueueable, said identifying resulting in an identified queue; retrieving congestion state information received from said separate queuing device; and optionally discarding said packet based on said retrieved congestion state information; and forwarding undiscarded packets towards said separate queuing device; and at said separate queuing device: enqueuing packets forwarded by said upstream device into a plurality of queues; maintaining congestion state information for each of said plurality of queues; and communicating said congestion state information to said upstream device.

In accordance with another aspect of the present invention there is provided a method of managing traffic at a device in a packet-based network, comprising: receiving packets; for a received packet: identifying a queue of a separate queuing device into which said packet is enqueueable, said identifying resulting in an identified queue; retrieving congestion state information received from said separate queuing device; and optionally discarding said packet based on said retrieved congestion state information; and forwarding undiscarded packets towards said separate queuing device.

In accordance with yet another aspect of the present invention there is provided a method of managing traffic at a device in a packet-based network, comprising: enqueuing packets forwarded by a separate upstream device into a plurality of queues; maintaining congestion state information including congestion notification information for each of said plurality of queues; and communicating said congestion state information to said separate upstream device for use in the optional discarding of packets.

In accordance with still another aspect of the present invention there is provided a device in a packet-based network, comprising: an input for receiving packets; and circuitry for, for a received packet: identifying a queue of a separate queuing device into which said packet is enqueueable, said identifying resulting in an identified queue; retrieving congestion state information received from said separate queuing device; and optionally discarding said packet based on said retrieved congestion state information.

In accordance with yet another aspect of the present invention there is provided a device in a packet-based network, comprising: a plurality of queues for enqueuing packets; circuitry for maintaining congestion state information including congestion notification state information for each of said plurality of queues; and circuitry for communicating said congestion state information to a separate upstream device for use in the optional discarding of packets.

In accordance with still another aspect of the present invention there is provided a computer-readable medium storing instructions which, when performed by an upstream device in a packet-based network, cause said device to: receive packets; for each received packet: identify a queue of a separate queuing device into which said packet is enqueueable, said identifying resulting in an identified queue; retrieve congestion state information received from said separate queuing device; and optionally discard said packet based on said retrieved congestion state information; and forward undiscarded packets towards said separate queuing device.

In accordance with yet another aspect of the present invention there is provided a computer-readable medium storing instructions which, when performed by a queuing device in a packet-based network, cause said device to: enqueue packets forwarded by a separate upstream device into a plurality of queues; maintain congestion state information for each of said plurality of queues; and communicate said congestion state information to said separate upstream device for use in the optional discarding of packets.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In the figures which illustrate example embodiments of this invention:

FIG. 1 is a schematic diagram illustrating a packet-based communications network;

FIG. 2 is a schematic diagram illustrating one of the nodes in the network of FIG. 1;

FIG. 3 is a schematic diagram illustrating one of the blades in the node of FIG. 2 which performs traffic management functions in accordance with the present invention;

FIG. 4 illustrates an upstream device of the blade of FIG. 3 in greater detail;

FIG. 5 illustrates a queuing device of the blade of FIG. 3 in greater detail;

FIG. 6 illustrates a packet forwarded from the upstream device of FIG. 3 to the queuing device of FIG. 4;

FIG. 7 illustrates an exemplary unit of congestion state, discard probability and aggregate congestion level information communicated from the queuing device of FIG. 4 to the upstream device of FIG. 3;

FIGS. 8A and 8B show operation at the upstream device of FIG. 3; and

FIGS. 9A and 9B show operation at the queuing device of FIG. 4.

### DETAILED DESCRIPTION

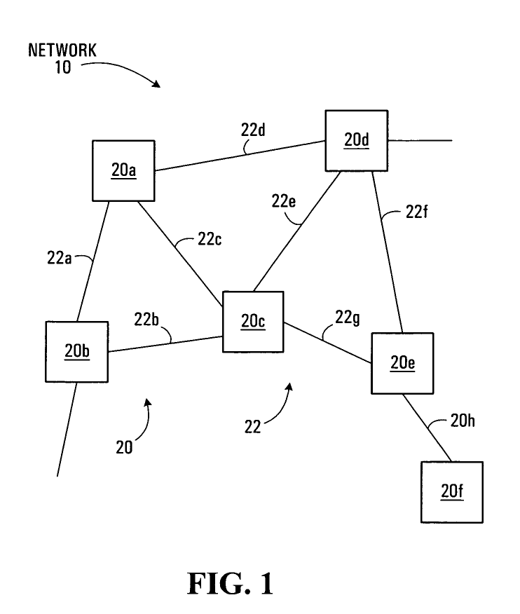

Referring to FIG. 1, a packet-based communications network is illustrated generally at 10. The network has six nodes 20a-20f (cumulatively nodes 20). Nodes 20 may be switches or routers, for example, which are capable of switching or routing packets through the network 10. The term “packet” as used herein is understood to refer to any fixed or variable size grouping of bits, i.e. a Protocol Data Unit, and as such may refer to cells (ATM) or frames (Frame Relay) for example.

Nodes 20 are interconnected by a set of links 22a-22h (cumulatively links 22). Links 22 may for example be physical interconnections comprising optical fibres, coaxial cable or other transmission media. Alternatively, links 22 may be logical interconnections.

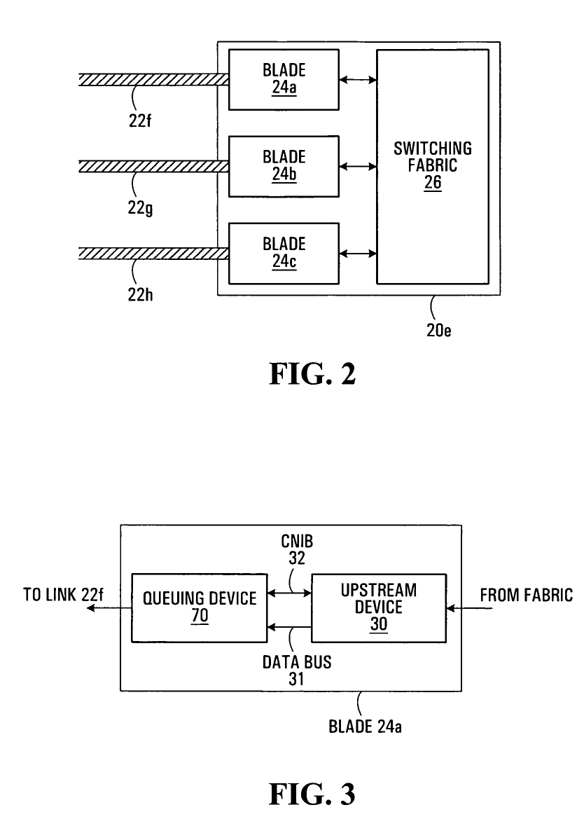

FIG. 2 illustrates an exemplary node 20e. Node 20e includes three blades 24a, 24b and 24c (cumulatively 24), each of which is interconnected to a particular link 22f, 22g and 22h, respectively, by way of a separate port (not illustrated). As is known in the art, a blade is a modular electronic circuit board which can be inserted into a space-saving rack with other blades. In the present case, each blade 22a, 22b and 22c receives packets from, and transmits packets over, its corresponding link 22f, 22g and 22h (respectively). As will be appreciated, traffic management functions according to the present embodiment are performed within each of the blades 24.

Node 20e further includes a switching fabric 26. Switching fabric 26 is responsible for switching packets entering the node 20e over one of the three links 22f, 22g, and 22h to the proper egress port/link so that the packet is forwarded to the correct next node in the network 10. Switching fabric 26 is interconnected to, and communicates with, each of the blades 24 in order to effect this objective.

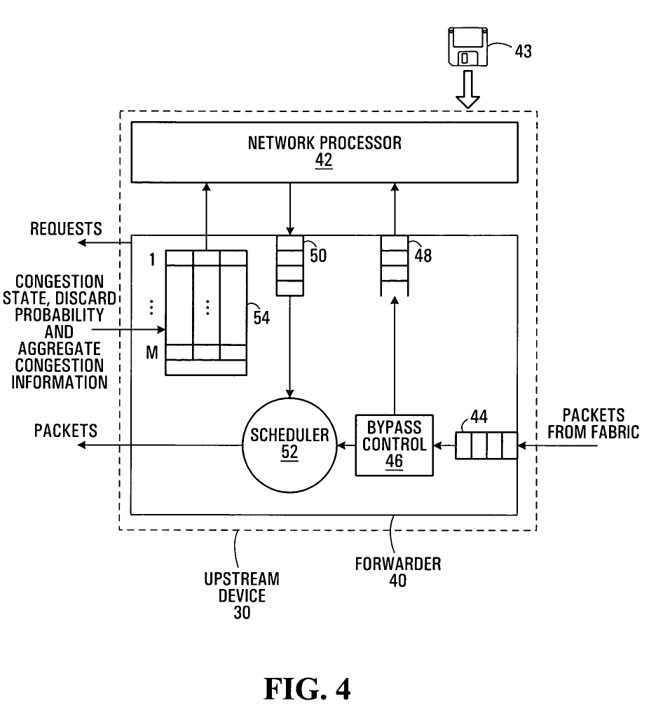

FIG. 3 illustrates blade 24a of FIG. 2 in greater detail. Only egress traffic management components of blade 24a, i.e., components which are responsible for performing traffic management for outgoing packets being transmitted from blade 24a to a next node in the network 10, are shown in FIG. 3. Ingress components of blade 24a are not illustrated.

Blade 24a includes an upstream device 30 and a queuing device 70. Upstream device 30 is referred to as being “upstream” of the queuing device 70 because the general flow of packet traffic through the blade 24a as illustrated in FIG. 3 is from right to left: packets are received by the upstream device 30 from switching fabric 26 and are processed (and possibly discarded, as will be described) by the upstream device 30. Thereafter, the (undiscarded) packets are forwarded to queuing device 70, where the packets are enqueued into one of a number of queues, pending transmission over link 22f. This right-to-left flow is referred to herein as the “forward” direction, for convenience.

In the present embodiment, upstream device 30 and queuing device 70 are both Application Specific Integrated Circuits (ASICs). Upstream device 30 is interconnected with queuing device 70 by way of two separate buses: a unidirectional data bus 31 and a bi-directional Congestion Notification Indication Bus (CNIB) 32. As will be appreciated, data bus 31 carries packets from the upstream device 30 to the queuing device 70 in accordance with forward packet flow, and CNIB 31 carries requests for congestion state and discard probability information in the forward direction, as well as units of congestion state, discard probability and aggregate congestion level information in the reverse direction (i.e. from queuing device 70 to upstream device 30). Cumulatively, the upstream device 30 and queuing device 70 are responsible for performing traffic management functions for the blade 24a of FIG. 3 in the egress direction.

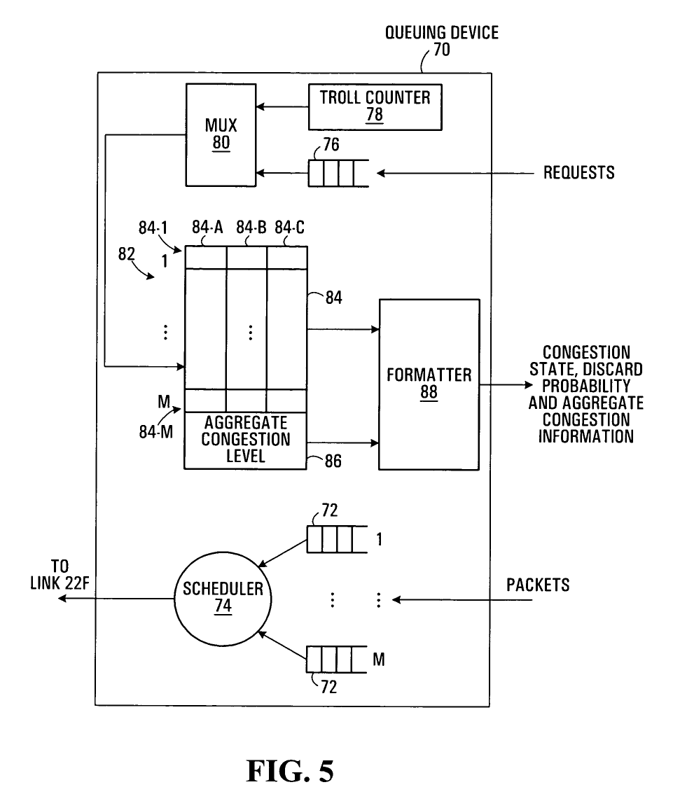

FIG. 4 illustrates the upstream device 30 in greater detail. The upstream device 30 device responsible for receiving packets and optionally discarding them or marking them as having experienced congestion based on the congestion present at the node 20e. The upstream device 30 performs OSI layer 3 processing (i.e. it understands layer 3 protocols such as the Internet Protocol), however, as will be appreciated, it also received updates comprising the aforementioned congestion information from the queuing device 70, which is representative of congestion at layer 2.

As can be seen in FIG. 4, the upstream device 30 comprises two devices in the present embodiment, namely, a forwarder 40 and a network processor 42. The forwarder 40 is interconnected with the network processor 42 by way of a bidirectional bus.

Forwarder 40 is an integrated circuit component which is generally responsible for: receiving packets from the switching fabric 26 (FIG. 2); determining whether the received packets are to receive service from the network process 42 or bypass it; passing packets requiring service from the forwarder 40 to the network processor 42 so that the service may be performed; and forwarding undiscarded packets to the queuing device 70 (FIG. 3). In the present embodiment, any packet that requires layer 3 processing or traffic management will be sent to the network processor 42. Layer 2 packets requiring no service from network processor 42 will be allowed to bypass to the queuing device 70 if the queuing device 70 is also capable of autonomous traffic management. Forwarder 40 is also responsible for caching congestion state, discard probability and aggregate congestion level information supplied by the queuing device 70. That is, forwarder 40 maintains a “shadow” copy of status information which was computed by the queuing device 70 for use by the upstream device 30 for optional packet discarding or marking purposes.

In accordance with these general responsibilities, forwarder 40 has various components comprising: a queue 44 for storing packets received from the switching fabric 26; a bypass control 46 for determining whether or not network processor service should be provided to received packets; a pair of queues 48 and 50 for storing packets passed to and received from (respectively) the network processor 42; a scheduler 52 for scheduling the forwarding of packets, which have either bypassed traffic management processing or which have been serviced by the network processor 42 and were not discarded, to the queuing device 70 (FIG. 3); and a memory 54 for caching congestion state, discard probability and aggregate congestion level information provided by the queuing device for reading as necessary by the network processor 42.

In the present embodiment, the memory 54 is local to the forwarder 40, however it should be appreciated that the memory 54 could be local to the network processor 42 or separate from the upstream device 30 (i.e. not local to the forwarder 40 or network processor 42) in alternative embodiments. The contents of the memory 54 are a shadow copy of the contents of memory at the queuing device 70, described below.

It will be appreciated that the bypass control 46 is not necessary implemented in hardware; it may be software based.

The network processor 42 of FIG. 4 is responsible for receiving packets from the forwarder 40 requiring layer 3 processing or traffic management processing (i.e. packets for which the network processor 42 was not bypassed). The network processor 42 performs either layer 3 processing or traffic management processing. Traffic management processing is performed in a manner that will be described below, using congestion state, discard probability and aggregate congestion level information read from the memory 54 of the forwarder 40 for this purpose. The result of the processing is that some packets may be discarded due to congestion at the blade 24a (or for other reasons that will be described), and undiscarded packets may be marked to indicate congestion at OSI layer 3. Undiscarded packets are passed back to the forwarder 40.

Upstream device 30 executes software loaded from computer readable medium 43 which includes layer 3 protocol specifics. The upstream device 30 is thus capable of being reprogrammed to support new protocols independently of the queuing device 70 while continuing to use the congestion state information update feature of the queuing device 70 which will be described.

The network processor 42 is also responsible for maintaining packet traffic statistics requiring knowledge of layer 3 protocols such as the IP.

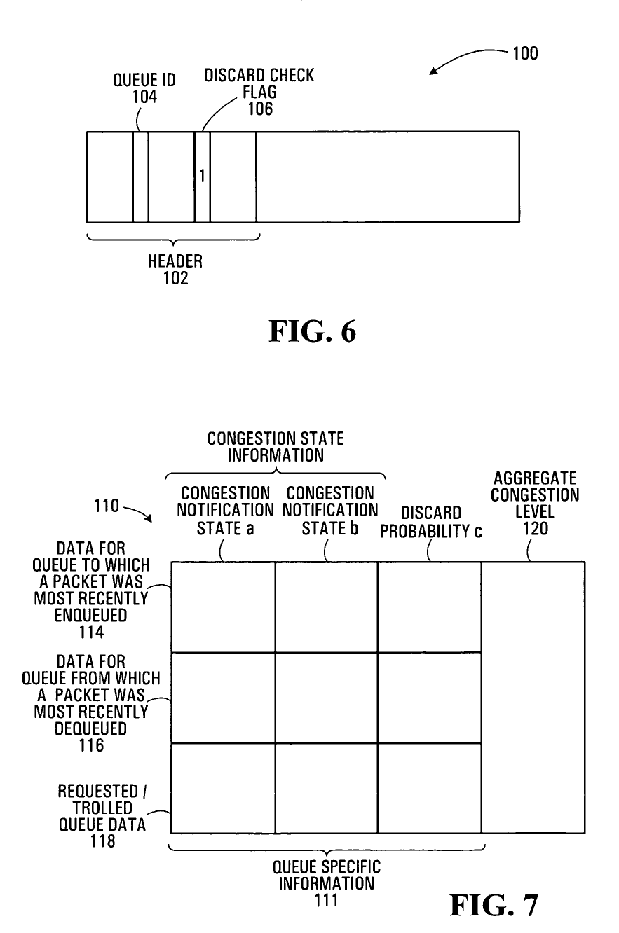

FIG. 5 illustrates the queuing device 70 of FIG. 3, which may alternatively be referred to as the downstream device 70, in greater detail. The queuing device 70 is generally responsible for enqueuing packets into one of M queues 72 (where M is a positive integer) and for scheduling the transmission of the enqueued packets over the link 22f (FIG. 2). Each of queues 72 is associated with a distinct OSI layer 2 connection; in the present example, these connections are ATM Virtual Channel Connections (VCCs). The queuing device 70 is also responsible for maintaining: congestion state information reflective of congestion at each of the queues 72 of the device 70; a discard probability for each of the queues 72; and an aggregate congestion level of the device 70, each of which will be described. The queuing device 70 updates the upstream device 30 with this information on an ongoing basis to effect the caching of information in memory 54 (FIG. 4). In the present embodiment, updating occurs on both a periodic and event-driven basis, with a view to limiting latency between memory 82 (FIG. 5) and memory 54 (FIG. 4).

The queuing device 70 of FIG. 5 has various components which facilitate the updating of upstream device 30 described above. For example, the device 70 has: a queue 76 for storing update requests for congestion state and discard probability information for specified queues; a troll counter 78 for cyclically generating the queue IDs of all of the M queues 72 of the queuing device 70, in order to periodically trigger updates for all queues even when update requests are only received in respect of some queues; a multiplexer 80 for multiplexing the requests from the upstream device 30 stored in queue 76 with the “trolled” (i.e. periodically generated) queue IDs from the troll counter 78; a memory 82 (which may be separate from the queuing device 70) for storing the congestion state, discard probability and aggregate congestion level information; and a formatter 88 for formatting this information prior to its provision to the upstream device 30.

Memory 82 is broken into two portions: queue-specific information 84 and non-queue specific information 86. Queue-specific information 84 includes congestion state information and discard probability information for each of the M queues 72 in rows 84-1 to 84-M. Non-queue specific information comprises an aggregate congestion level 86 for the queuing device 70.

Referring to the queue-specific information 84, each row 84-1 to 84-M has three columns or fields. The first two columns a and b contain congestion state information for the associated queue while the third column c contains discard probability information for the associated queue.

Congestion state information includes a congestion notification state in column 84-a and a congestion indication state in column 84-b. A congestion notification state represents a congestion state which is determinative of whether or not a packet should be discarded to alleviate congestion. A congestion indication state, on the other hand, represents a congestion state which is determinative of whether or not a packet should be marked as having experienced congestion at OSI layer 3. Both of the congestion notification states and the congestion indication states may be enumerated types representative of discrete congestion levels, such as NO_CONGESTION, LOW_CONGESTION, MEDIUM_CONGESTION, and HIGH_CONGESTION. It will be appreciated that the congestion notification state and congestion indication state for a particular queue may be different due to the use of different thresholds (e.g. portions of queue capacity to be filled) by queuing device 70 to determine these states. It is noted that packets may also be marked as having experienced congestion at layer 2 (e.g. ATM and Frame Relay).

Discard probability information 84-c for the M queues 72 consists of a probability for each queue that packets destined for that queue will be discarded in order to effectively communicate to a source node that congestion is being experienced (e.g. in accordance with the RED scheme). A discard probability value for a queue is not necessarily related to the congestion notification state or congestion indication state value for that queue.

The non queue-specific aggregate congestion level 86 for the device 70 in the present embodiment reflects an overall amount of unused queue space at the queuing device 70. A small amount of remaining unused space results in a high aggregate congestion level. The aggregate congestion level 86 may be an enumerated type, as described above.

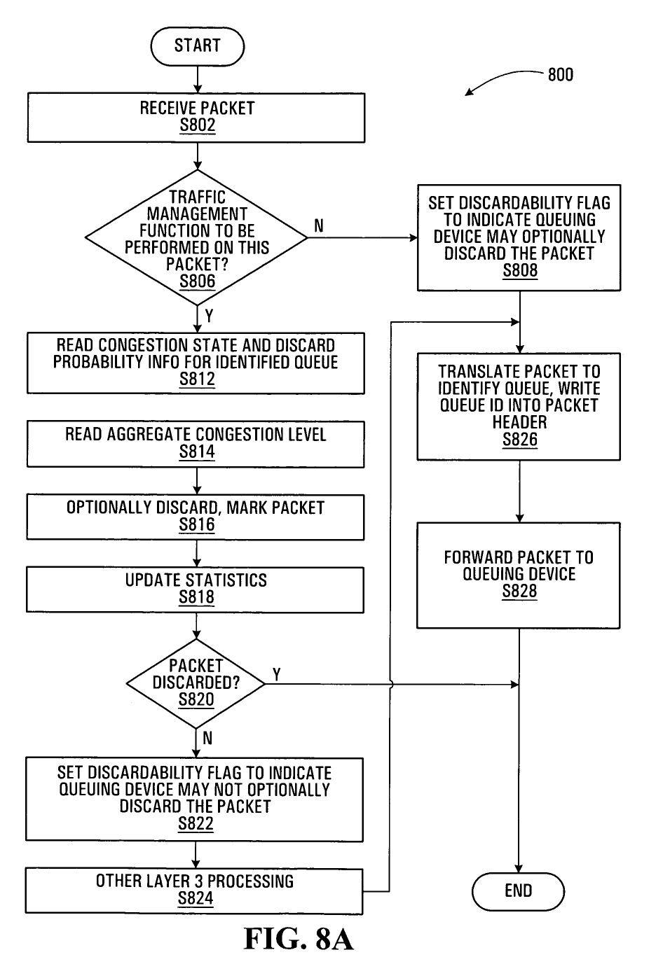

FIG. 6 illustrates an exemplary packet 100 which has been forwarded to the queuing device 70 after processing by the upstream device 30. The packet 100 of FIG. 6 of the present example is an IP packet with an affixed a proprietary header 102. The header 102 is affixed to the IP packet during processing of the IP packet at the network node 20e for purposes of transferring the packet within the node, and will be removed before the packet is sent over a link to another network node. The header 102 contains two fields 104 and 106.

Queue ID field 104 contains a unique ID of one of the queues 72 of device 70 (FIG. 5) which is identified by the upstream device 30, through translation of packet header information, as being the queue into which packet 100 is enqueueable, i.e., into which the packet would be enqueued assuming that the packet were be forwarded to the device 70. Each received packet is properly enqueuable into only one of the M queues 72, which queue is identified by a unique ID that is simply an integer in the present embodiment. The queue ID is stored into field 104 so that queuing device 70 may simply read the queue ID from that field in order to determine which queue should enqueue the packet, such that the translation performed by the upstream device 30 does not need to be repeated at the queuing device 70.

Field 106 is a discard check indicator comprising a discard check flag which indicates to the queuing device 70 whether or not the device 70 may perform traditional layer 2 traffic management processing, including optional discarding, on that packet. In FIG. 6, the flag is set with a value “1” to indicate that a discard check has already been performed on the packet by the upstream device 30. Putting it another way, a value of “1” indicates that traffic management functions according to an embodiment of the present invention have already been performed on the packet at the upstream device 30, and that the queuing device 70 should therefore abstain from performing traditional layer 2 traffic management processing on the packet. A value of “0” would indicate that a discard check has not yet been performed on the packet by the upstream device. The latter setting may result when a determination is made at the upstream device 30 that traffic management functions according to an embodiment of the present invention should be bypassed at the upstream device 30. This setting may also result when the network processor 42 has processed the packet without making any discard decisions for the packet. It is of course appreciated that the values “0” and “1” could be reversed in alternative embodiments.

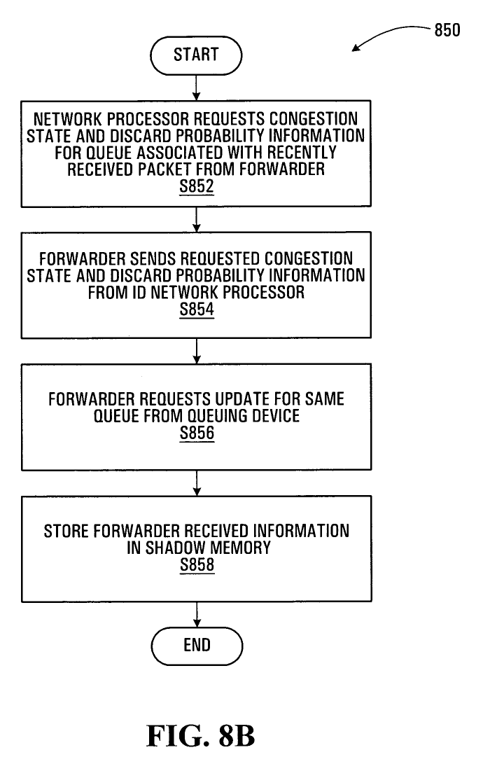

FIG. 7 illustrates an exemplary unit of information 110 containing congestion state, discard probability and aggregate congestion level information which is communicated from the queuing device 70 to the upstream device 30. The unit of information 110, which may be a message or record for example, is formatted by the formatter 88 (FIG. 5) using information read from the memory 82.

As may be seen in FIG. 7, the unit of information 110 includes queue-specific information 111, including congestion state and discard probability information, as well as non queue-specific information comprising aggregate congestion level 120. In the present embodiment, the unit of information 110 includes queue-specific information for three queues: the queue to which a packet was most recently enqueued at the queuing device 70 (row 114); the queue from which a packet was most recently dequeued at the queuing device 70 (row 116); and a requested or trolled queue (row 118).

The motivation for including information for the queues to which a packet was most recently enqueued and dequeued at the queuing device 70 (rows 114 and 116) is to keep the upstream device 30 updated regarding the state of queues whose congestion state and discard probability may have recently changed due to the recent addition or removal of a packet. That is, update information is provided for “active” queues, to promote coherence and to limit latency between the congestion state and discard probability information maintained by the queuing device 70 in memory 82 and the “shadow” copy of this information cached in the memory 54 of forwarder 40. Other embodiments may provide queue-specific information for different queues.

The requested or trolled queue information in row 118 represents queue-specific information for either a queue for which information was recently requested by the upstream device 30 (by way of a request sent to queue 76 of FIG. 5) or a queue whose ID was recently generated by the troll counter 78. The multiplexer 80 (FIG. 5) determines which of these two alternatives is written to row 118 for the current unit of information 110. The motivation for including information responsive to a request from the upstream device 30 is, again, to promote coherence between the memory 82 and the “shadow” memory 54. Coherence is promoted because the requests from the upstream device 30 will be in respect of queues for which congestion state information has recently been retrieved from the shadow memory 54, in response to a recent receipt of packets that are enqueueable to those “active” queues. The rationale for providing information regarding a queue whose ID was generated by the troll counter 78, on the other hand, is to ensure that updates to the upstream device 30 are periodically triggered for all queues, even inactive ones.

It will be appreciated that the information in rows 114, 116 and 118 may pertain to the same queue, or to two or three different queues (e.g. rows 114 and 116 may pertain to the same queue while row 118 pertains to another queue).

Queue-specific information 111 (that is, rows 114, 116 and 118) spans three columns a, b, and c, representing congestion notification state information, congestion indication state information, and discard probability information respectively. These columns contain the same information as is stored in columns 84-a to 84-c respectively of the corresponding row(s) of memory 82 (FIG. 5).

The aggregate congestion level 120 of FIG. 7 is the same as the aggregate congestion level 86 stored in memory 82. This information forms part of every unit of information 110 sent from the queuing device 70 to the upstream device 30 because, as will be appreciated, it can have a strong bearing on whether or not packets are discarded by the upstream device 30.

In overview, each packet received by the upstream device 30 from the switching fabric 26 (which packet will typically be a layer 3 packet or layer 2 packet) is processed to determine whether layer 3 processing or traffic management functions according to the present invention should be performed on the packet.

If a determination is made that neither layer 3 processor nor traffic management functions should performed for the packet, e.g. as may be the case for ATM bearer service packets (i.e. when ATM packets/cells are accepted for switching to a particular destination without encapsulation or interworking with other higher layer protocols or services), a discard check flag in the packet is cleared to indicate to the queuing device 70 that the device 70 may perform traditional layer 2 traffic management processing, including optional discarding, on that packet if desired, and the packet is forwarded to the queuing device 70, bypassing the network processor 42.

If, on the other hand, a determination is made that layer 3 processing or traffic management functions should be performed, the packet is passed to the network processor 42 (FIG. 4). The network processor 42 then reads congestion state information for the identified queue and aggregate congestion level information from the shadow memory 54 of forwarder 40 and, based on this information, optionally discards the packet and, for undiscarded packets, optionally marks the packet as having experienced congestion.

The network processor 42 also reads discard probability information cached in memory 82 and, based on this information, further optionally discards the packet, if it is necessary to effectively communicate to a source node that congestion is being experienced (as will occur when the lost packet is interpreted by the source node as being indicative of congestion).

For undiscarded packets which survive optional discarding, a discard check flag is set in the packet to indicate traffic management processing has already been performed on the packet, to prevent queuing device 70 from performing traditional processing on the packet. Undiscarded packets are forwarded to the queuing device 70 over the data bus 32 (FIG. 3).

The network processor 42 also generates requests for congestion state and discard probability information for active queues and sends these requests to the queuing device 70 over CNIB 31, as described above.

As well, the network processor 42 compiles packet traffic statistics for layer 3 and layer 2, including a number of packets discarded per layer 3 flow (e.g. per unique destination IP address) and a number of packets discarded per layer 2 connection (e.g. per ATM VCC). Advantageously, the layer 3 statistics will reflect discards and marking performed responsive to layer 2 congestion.

Regardless of whether network processor 42 was bypassed, each undiscarded packet is translated to determine which one of the M queues 72 of queuing device 70 is the proper queue into which the layer 2 packet(s) associated with the layer 3 packet is/are enqueueable. For each associated layer 2 packet, the unique ID of the proper queue is written to the packet header for later reference by the queuing device 70.

The queuing device 70 receives undiscarded packets forwarded by the upstream device 30. If the flag in the packet dictates that the packet is discardable, traditional layer 2 traffic management processing, which may result in optional discarding/marking of the packet, is performed. Regardless of whether traditional layer 2 traffic management processing is performed, the received packets are enqueued into a queue 72 and ultimately scheduled for transmission out over the link 22f.

The queuing device also computes congestion states for each of its queues based on the queues' degree of used capacity. In the present embodiment, two types of congestion states, each based on a distinct threshold, are computed for each queue: a congestion notification state and a congestion indication state. The queuing device 70 further computes discard probabilities for each of its queues in accordance with the RED scheme, as well as an aggregate congestion level for the device 70 (as defined above).

Periodically, the queuing device 70 bundles the congestion notification state, congestion indication state, and discard probability for each of three queues with the current aggregate congestion level to form a unit of information 110 (FIG. 7), which is sent back to the upstream device 30 in the reverse direction over the CNIB 31. The three queues are selected on the basis that they are “active” queues, in an effort to keep the shadow memory 54 as current as possible (i.e. to limit latency between memory 82 and memory 54).

Thus the upstream device 30 is empowered to perform all discards (including layer 3 discards) at the blade 24a using congestion state and discard probability information (i.e. layer 2 information) provided by the queuing device 70, with the typically labor-intensive computation of this information being handled by the latter device.

As may be appreciated, apportionment of traffic management functions according to the present embodiment is advantageous in a number of respects. For example, the layer 3 statistics maintained at upstream device 30 will integrate discards performed due to congestion at layer 2 and will therefore be more accurate than statistics in conventional approaches which do not reflect layer 2 discards. This integration is made possible because upstream device 30 is aware of both layer 3 protocols and layer 2 congestion.

As well, in the present embodiment, the upstream device's assessment of congestion for purposes of congestion marking is based on state of the main buffers/queues rather than small buffers at the upstream device. Therefore the assessment more accurately reflects congestion at the devices as a whole, as compared to the discard notification architecture for example.

Finally, the present embodiment is less wasteful of the upstream device's processing bandwidth than the discrete layer 3 and layer 2 processing architecture because the upstream device may abstain from performing layer 3 processing for packets which are to be discarded. That is, if the state of the queues at the queuing device 70, as reflected in unit of information 110 (which is passed back to upstream device 30), dictates that a layer 3 packet is to be discarded, the packet may be discarded prior to engaging in further layer 3 processing. This may conserve processing bandwidth at the upstream device.

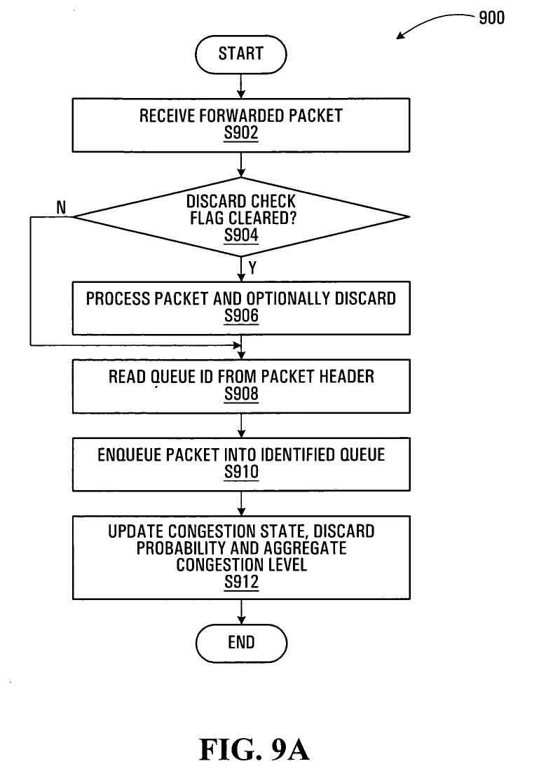

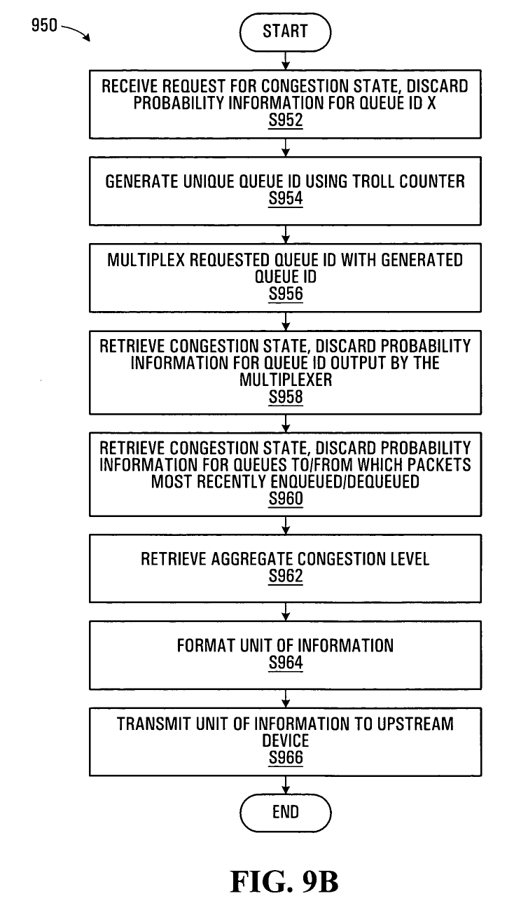

Operation of the present embodiment is illustrated in FIGS. 8A, 8B, 9A and 9B. FIGS. 8A and 8B illustrate operation at the upstream device 30 while FIGS. 9A and 9B illustrate operation at the queuing device 70. FIGS. 8A and 9A describe packet processing at the two devices 30 and 70, while FIGS. 8B and 9B generally describe the manner in which the two devices cooperate to regularly update the shadow memory cache 54.

Referring to FIG. 8A, operation 800 at the upstream device 30 for processing packets is illustrated for a single exemplary packet. Initially, the packet is received by the upstream device 30 from the switching fabric 26 (S802). In the present example, the packet is assumed to be an IP packet.

Next, the bypass control 46 (FIG. 4) determines whether or not traffic management functions should be performed on this packet (S804). This determination typically involves a determination of a packet type for the packet and a comparison of the determined packet type with a list of types of packets for which traffic management functions at the upstream device 30 should be bypassed.

If the bypass control 46 determines that no traffic management functions or layer 3 processing should be performed on this packet, a discard check flag in the packet is set to “0” to indicate that no discard check has been performed, and that the queuing device 70 is free to perform traditional, layer 2 traffic management processing on the packet, which may result in the optional discarding of the packet (S808). The packet is then forwarded to the queuing device 70 (S810) by way of the scheduler 52 (FIG. 4).

If, on the other hand, the bypass control 46 determines (in S806) that layer 3 processing or traffic management functions should in fact be performed on this packet, the packet is passed to the network processor 42 via queue 48 (FIG. 4).

When the network processor 42 receives the packet from queue 48, it translates the IP packet to determine the ID of the queue 72 of the queuing device 70 (FIG. 5) into which the packet is enqueuable. This queue ID is used to retrieve congestion state and discard probability information 56 for the associated queue from memory 54 (S812). The network processor 42 additionally retrieves the aggregate congestion level of queuing device 70 from memory 54 (S814). The network processor 42 then uses this information in order to optionally discard or mark the packet (S816).

Discarding of the packet may occur in two cases.

First, the packet may be discarded if an excessive degree of congestion is detected at the queue to which the packet is enqueuable or is detected at queuing device 70 at an aggregate level. In this case, the retrieved congestion state information—specifically, congestion notification state—is compared to the aggregate congestion level. If the queue-specific congestion state represents a degree of congestion that is greater than or equal to the aggregate congestion level, the queue-specific congestion state is used to determine whether or not the packet should be discarded. Otherwise, the aggregate congestion level is used. In other words, the aggregate congestion level can “override” the queue-specific congestion state information when it represents a greater degree of congestion. In this sense, it will be recognized that the aggregate congestion level can have a strong bearing on whether or not packets are discarded by the upstream device 30: if the aggregate congestion level indicates a high level of congestion, it may consistently override the queue-specific congestion notification state for multiple queues and result in many discards. The selected congestion level is then compared against a threshold, and if the congestion level exceeds the threshold, the packet is discarded. The purpose of this discard, if it occurs, is to alleviate congestion at the blade 24a.

For example, if the congestion notification state for the queue into which the packet is enqueueable is LOW_CONGESTION and the aggregate congestion level for the queuing device is HIGH_CONGESTION, the higher of the two (i.e. the latter) may be compared against a threshold which is set at MEDIUM_CONGESTION. Because the congestion state HIGH_CONGESTION exceeds the MEDIUM_CONGESTION threshold, the packet is discarded.

It should be noted that the provision of the aggregate congestion level to the queuing device 70 for use in the optional discarding of packets provides can significantly limit latency as compared with other approaches of determining congestion state information. For example, if in another approach the congestion states computed by the queuing device 70 were effective congestion states which were representative not only of congestion at a particular queue but also at a higher level of aggregation, such as at the queuing device 70 overall (i.e. reflecting both individual queue states and the aggregate congestion level), a change in the aggregate congestion level may simultaneous change the effective congestion state of many queues. If it were necessary to wait for congestion state updates from the queuing device 70 in respect of each queue whose status changed, a significant delay could be introduced before all of the states were updated at the shadow memory 54. Instead, by communicating the aggregate congestion level to the upstream device 30 for “merging” with individual queue states at that device, such delay can be avoided.

Second, the packet may be discarded based on the retrieved discard probability. For example, if the retrieved discard probability is 0.5, there is a 50% chance that the packet will be discarded. The purpose of this discard, if it occurs, is to effectively signal the source node in the network 10 which sent the packet to reduce its rate of transmitting packets.

Marking of the packet as having experienced congestion may occur if an excessive degree of congestion is detected at the queue to which the packet is enqueuable or at queuing device 70 at an aggregate level. In this case, however, it is a congestion indication state (versus congestion notification state) for the queue that is compared against a threshold. If the threshold is exceeded, the packet is marked as having experienced congestion. Advantageously, marking can occur in accordance with the layer 3 protocol understood only by the upstream device 30 while accounting for the state of the relevant queue and aggregate congestion at the queuing device 70.

If the packet was not discarded (S820), the network processor 42 next sets the discard check flag (field 106) of the packet to “1” to indicate that traffic management functions have been performed on the packet at the upstream device 30, and that the queuing device 70 should therefore abstain from performing traditional layer 2 traffic management processing on the packet (S822). Other layer 3 processing may then be performed (S824). The packet is then forwarded to the queuing device 70 over data bus 32, by way of queue 50 and scheduler 52 of forwarder 40 (S826). The purpose of the scheduler 52 is to schedule transmission of undiscarded packets received either from the queue 50 or the bypass control 46 over data bus 32. Operation 800 is thus concluded.

Turning to FIG. 8B, operation 850 at the upstream device 30 for updating the shadow memory 54 is illustrated. When a packet is received from switching fabric 26 at upstream device 30 (S802 of FIG. 8A) and its associated queue identified (S826), a request for congestion state and discard probability information for the identified queue is sent from the network processor 42 to the forwarder 40 (S852), with the motivation being to trigger an update of the congestion state and discard probability information 56 of memory 54 for active queues. The forwarder 40 quickly responds by providing the requested information from its “shadow” memory 54 (S854).

Subsequently, the forwarder 40 sends a request for an update for the same queue to the queuing device 70 over CNIB 31 (FIG. 3) (S856). In response to the request, the queuing device 70 will send a unit of information 110 including congestion state and discard probability information for a requested or trolled queue (row 118 of FIG. 7). The unit of information will also include the congestion state and discard probability information in respect of the queue(s) to/from which queuing device 70 has most recently enqueued/dequeued a packet (rows 114, 116 of FIG. 7) as well as aggregate congestion level information 120. The unit of information 110, which is sent over CNIB 31 in the reverse direction, is received by the upstream device 30 (S858). The upstream device 30 then stores the received information into the appropriate fields of “shadow” memory 54. Operation 850 is thus concluded.

Referring now to FIG. 9A, operation 900 at the queuing device 70 for processing packets is illustrated for a single exemplary packet. Initially, the packet forwarded from the upstream device 30 (in S828, above) is received by the queuing device 70 (S902) over data bus 32. If the discard check flag in the packet header is clear (S904), the queueing device engages in traditional layer 2 traffic management processing, which may have the effect of discarding the packet (S906). Assuming the packet is not discarded, the queue ID is read from field 104 of the packet (FIG. 6) to determine the ID of the queue 72 (FIG. 5) of queuing device 70 into which the packet is enqueueable (S908), and the packet is enqueued into the identified queue (S910). Subsequently, dequeuing of the packet from the identified queue and transmission of the packet over link 22f is scheduled by the scheduler 74. Finally, the congestion state information 84-a to 84-b, discard probability information 84-c and aggregate congestion level information 86 is recomputed to reflect recent enqueuing/dequeuing of packets and stored in memory 82 (S912). Operation 900 is thus concluded.

Turning to FIG. 9B, operation 950 at the queuing device 70 for updating the shadow memory 54 of upstream device 30 with congestion state, discard probability and aggregate congestion level information is illustrated. Initially, a request for congestion state and discard probability information in respect of a particular queue (which request was generated by the upstream device 30 at S852 of FIG. 8B, described above) is received by the queuing device 70 (S952) over CNIB 31. The troll counter 78 (FIG. 5) then generates a unique queue ID (S954). The generated queue ID is one of a sequence of queue IDs identifying all of the queues 72, which sequence is repeatedly generated by the troll counter 78. Note that S952 and S954 may be performed in reverse order or in parallel.

The ID of the queue for which a request was received in S952 and the queue ID generated in S954 are then multiplexed by the multiplexer 80 (S956). Multiplexing may be performed in various ways. For example, the multiplexer 80 may merely alternate between requested and trolled queue IDs. Congestion state and discard probability information is then retrieved from memory 82 for the queue ID output by the multiplexer 80 (S958). As well, congestion state and discard probability information is retrieved from memory 82 for the queues to which a packet was most recently enqueued and from which a packet was most recently dequeued (S960) at queuing device 70. Further, the current aggregate congestion level 86 at queuing device 70 is retrieved from the memory 82 (S962). The retrieved information is then formatted into a unit of information 110 (FIG. 7) by the formatter 88, and the resultant unit of information 110 is transmitted to the upstream device 30 over CNIB 31 (FIG. 3). Operation 950 is thus concluded.

As will be appreciated by those skilled in the art, modifications to the above-described embodiment can be made without departing from the essence of the invention. For example, although congestion state information should minimally include congestion notification information, it does not necessarily include congestion indication state information. The latter information may not be needed if the upstream device 30 is not tasked with performing congestion marking.

As well, if no scheme akin to the RED scheme is being implemented, it may not be necessary for the queuing device 70 device to compute discard probabilities for each of its queues or to forward same to the upstream device 30 for local caching.

Further, it is not necessary for the queuing device 70 to regularly compute an aggregate congestion level and forward same to the upstream device 30 for use in optional discarding of packets. Rather, optional discarding or marking of packets may only be based on individual queue states. Alternatively, the aggregate congestion level could be merged with individual queue states at the queuing device 70 to create an “effective congestion state” (with the caveat that this may increase latency, as described above).

In another alternative, it may be possible for updates of congestion state, discard probability or aggregate congestion level information to be exclusively periodic, rather than a combination of being periodic and event-based, as in the above described embodiment. For example, the updates may be periodically sent if the number of queues is small, such that even if many queues changes states at once, these state changes could be communicated quickly due to the fact that the number of queues is small. Such periodic updates may not need to prioritize updates for recently enqueued or dequeued queues over other queues, again due to an acceptable upper limit on latency that is inherent in the small number of queues. Alternatively, the updates could be entirely event-based.

It is not necessary for the upstream device 30 to be divided into a forwarder 40 and a network processor 42. For example, if the performance of layer 3 processing or traffic management functions is mandatory, rather than being optional as in the above embodiment, it may be more convenient to implement upstream device 30 without subdivision into a forwarder and a network processor.

It will be also appreciated that network processor 42 may perform functions other than layer 3 processing and traffic management functions. In this case, the decision of the forwarder 40 as to whether to send packets to the network processor 42 may be based on criteria other than whether layer 3 processing or traffic management functions are to be performed on the packet.

As well, it will be appreciated that the layer 3/layer 2 split of functionality between upstream/downstream devices is not rigid. Some layer 2 functions may be performed in the upstream device in alternative embodiments.

Additionally, it will be appreciated that the congestion state information maintained by the queuing device 70 and communicated to upstream device 30 may include information other than congestion notification state and congestion indication state. For example, the congestion state information may include other state information for the queuing device 70 and/or resources that it manages, optionally including other forms of discard state, congestion marking state, traffic management state, performance monitoring state, fault state, and/or configuration state, for the queues, connections, sub-connections, flows, schedulers, memories, interfaces, and/or other resources of the queuing device. Moreover, discard probability information may account for loss priority, drop precedence, and/or traffic class.

Finally, while the above embodiments have been described in connection with packets associated with OSI layers 2 and 3, it will be appreciated that the present invention is not necessarily limited to packets associated with these layers. That is, the invention may alternatively be applicable to packets associated with any combination of OSI layers or any combination of different protocols at the same OSI layer, or a division of functions for a single protocol at a single OSI layer.

Other modifications will be apparent to those skilled in the art and, therefore, the invention is defined in the claims.

1. A method of managing traffic in a packet-based network, comprising:
at an upstream device:
receiving packets;
for a received packet:
identifying a queue of a separate queuing device into which said packet is enqueueable, said identifying resulting in an identified queue;
retrieving congestion state information received from said separate queuing device; and
optionally discarding said packet based on said retrieved congestion state information; and
forwarding undiscarded packets towards said separate queuing device; and at said separate queuing device:
enqueuing packets forwarded by said upstream device into a plurality of queues;
maintaining congestion state information for each of said plurality of queues; and
communicating said congestion state information to said upstream device.

2. The method of claim 1 wherein said congestion state information includes congestion state notification information for said identified queue.

3. A method of managing traffic at a device in a packet-based network, comprising:
receiving packets;
for a received packet:
identifying a queue of a separate queuing device into which said packet is enqueueable, said identifying resulting in an identified queue;
retrieving congestion state information received from said separate queuing device; and
optionally discarding said packet based on said retrieved congestion state information; and
forwarding undiscarded packets towards said separate queuing device.

4. The method of claim 3 wherein said congestion state information includes congestion state notification information for said identified queue.

5. A method of managing traffic at a device in a packet-based network, comprising:
enqueuing packets forwarded by a separate upstream device into a plurality of queues;
maintaining congestion state information including congestion notification state information for each of said plurality of queues; and
communicating said congestion state information to said separate upstream device for use in the optional discarding of packets.

6. A device in a packet-based network, comprising:
an input for receiving packets; and
circuitry for, for a received packet:
identifying a queue of a separate queuing device into which said packet is enqueueable, said identifying resulting in an identified queue;
retrieving congestion state information received from said separate queuing device; and
optionally discarding said packet based on said retrieved congestion state information.

7. The device of claim 6 wherein said congestion state information includes congestion notification state information for said identified queue of said separate queuing device

8. The device of claim 6, further comprising:
circuitry for, upon said identifying, sending a request to said separate queuing device for congestion state information for said identified queue.

9. The device of claim 6 further comprising:
circuitry for receiving congestion state information for a plurality of queues maintained at said separate queuing device;
a cache for caching said congestion state information.

10. The device of claim 6 wherein said congestion state information further includes congestion indication state information, and further comprising circuitry for optionally marking a received packet as having experienced congestion based on said congestion indication state information.

11. The device of claim 10 further comprising circuitry for maintaining statistics based on said optionally marking

12. The device of claim 6 further comprising circuitry for maintaining statistics based on said optional discarding.

13. The device of claim 12 wherein said statistics are in respect of Open Systems Interconnection Reference Model layer 3 flows.

14. The device of claim 6 further comprising circuitry for, for a received packet, storing the identity of said identified queue in said packet.

15. The device of claim 6 further comprising:
circuitry for, for a received packet:
determining a type of said packet; and
bypassing said retrieving and said optional discarding if said determined packet type is one of a predetermined set of packet types.

16. The device of claim 15 further comprising circuitry for, for a received packet, setting a discard check indicator associated with said packet to indicate that no discard check has been performed on said packet if said determined packet type is one of said predetermined set of packet types.

17. The device of claim 15 further comprising circuitry for, for a received packet, setting a discard check indicator associated with said packet to indicate that a discard check has been performed on said packet if said determined packet type is not one of said predetermined set of packet types.

18. The device of claim 6 further comprising:
circuitry for retrieving a discard probability for said identified queue of said separate queuing device; and
circuitry for further optionally discarding said packet based on said discard probability.

19. The device of claim 18 wherein said discard probability is in respect of the Random Early Detection scheme.

20. The device of claim 18 further comprising circuitry for maintaining statistics based on said optional discarding.

21. The device of claim 6 further comprising circuitry for retrieving an aggregate congestion level of said separate queuing device, wherein said circuitry for optionally discarding said packet further bases said optional discarding on said aggregate congestion level.

22. The device of claim 21 wherein said circuitry for optionally discarding said packet performs said optional discarding based on whichever of said congestion state information for said identified queue and said aggregate congestion level represents a greater degree of congestion.

23. A device in a packet-based network, comprising:
a plurality of queues for enqueuing packets;
circuitry for maintaining congestion state information including congestion notification state information for each of said plurality of queues; and
circuitry for communicating said congestion state information to a separate upstream device for use in the optional discarding of packets.

24. The device of claim 23 further comprising circuitry for triggering said circuitry for communicating to communicate said congestion state information periodically.

25. The device of claim 23 further comprising circuitry for triggering said circuitry for communicating to communicate congestion state information for a queue into which a packet was most recently enqueued in addition to triggering said circuitry for communicating to communicate congestion state information for other queues.

26. The device of claim 23 further comprising circuitry for triggering said circuitry for communicating to communicate congestion state information for a queue from which a packet was most recently dequeued in addition to triggering said circuitry for communicating to communicate congestion state information for other queues.

27. The device of claim 23 further comprising circuitry for receiving a request from said separate upstream device for congestion state information for a specified queue, and wherein said circuitry for communicating communicates the congestion state information for said specified queue in response to said request.

28. The device of claim 23 further comprising:
circuitry for maintaining discard probability information for each of said plurality of queues; and
circuitry for communicating said discard probability information to said separate upstream device.

29. The device of claim 23 further comprising:
circuitry for determining an aggregate congestion level at said queuing device; and
circuitry for communicating said aggregate congestion level to said separate upstream device.

30. The device of claim 23 further comprising:
circuitry for receiving packets;
circuitry for inspecting a discard check indicator associated with a received packet; and
circuitry for optionally discarding the received packet based on said discard check indicator.

31. A computer-readable medium storing instructions which, when performed by an upstream device in a packet-based network, cause said device to:
receive packets;
for a received packet:
identify a queue of a separate queuing device into which said packet is enqueueable, said identifying resulting in an identified queue;
retrieve congestion state information received from said separate queuing device; and
optionally discard said packet based on said retrieved congestion state information; and
forward undiscarded packets towards said separate queuing device.

32. The computer-readable medium of claim 31 wherein said congestion state information includes congestion state notification information for said identified queue.

33. The computer-readable medium of claim 31 wherein said instructions further cause said device to:
upon said identifying, send a request to said separate queuing device for congestion state information for said identified queue.

34. The computer-readable medium of claim 31 wherein said instructions further cause said device to maintain statistics based on said optional discard.

35. The computer-readable medium of claim 34 wherein said statistics are in respect of Open Systems Interconnection Reference Model layer 3 flows.

36. The computer-readable medium of claim 31 wherein said instructions further cause said device to, for a received packet, store an identifier of said identified queue in said packet.

37. The computer-readable medium of claim 31 wherein said instructions further cause said device to:
for a received packet:
determine a type of said packet; and
bypass said retrieve and said optional discard if said determined packet type is one of a predetermined set of packet types.

38. The computer-readable medium of claim 37 wherein said predetermined set of packet types includes Asynchronous Transfer Mode (ATM) bearer service packets.

39. The computer-readable medium of claim 37 wherein said instructions further cause said device to:
for a received packet, if said determined packet type is one of said predetermined set of packet types, set a discard check indicator associated with said packet to indicate that said packet is discardable by said separate queuing device.

40. The computer-readable medium of claim 37 wherein said instructions further cause said device to:
for a received packet, if said determined packet type is not one of said predetermined set of packet types, set said discard check indicator associated with said packet to indicate that said packet is not discardable by said separate queuing device.

41. The computer-readable medium of claim 31 wherein said congestion state information further includes congestion indication state information.

42. The computer-readable medium of claim 31 wherein said instructions further cause said device to:
for a received packet:
retrieve a discard probability for said identified queue; and
further optionally discard said packet based on said discard probability.

43. The computer-readable medium of claim 31 wherein said instructions further cause said device to retrieve an aggregate congestion level of said separate queuing device, and wherein said optional discard is further based on said aggregate congestion level.

44. The computer-readable medium of claim 43 wherein said optional discard is governed by whichever of said congestion state information for said identified queue and said aggregate congestion level represents a greater degree of congestion.

45. A computer-readable medium storing instructions which, when performed by a queuing device in a packet-based network, cause said device to:
enqueue packets forwarded by a separate upstream device into a plurality of queues;
maintain congestion state information including congestion notification information for each of said plurality of queues; and
communicate said congestion state information to said separate upstream device for use in the optional discarding of packets.

46. The computer-readable medium of claim 45 wherein said instructions cause said communicate to occur periodically for each of said plurality of queues.

47. The computer-readable medium of claim 45 wherein said instructions cause said communicate to be triggered for a queue which has most recently enqueued a packet before it is triggered for other queues.

48. The computer-readable medium of claim 45 wherein said instructions cause said communicate to be triggered for a queue which has most recently dequeued a packet before it is triggered for other queues.

49. The computer-readable medium of claim 45 wherein said instructions further cause said device to receive requests for congestion state information for a specified queue from said separate upstream device, and wherein said communicate communicates congestion state information for said specified queue in response to said request.

50. The computer-readable medium of claim 45 wherein said enqueue comprises, for a particular packet, identify from a queue identifier in said packet one of said plurality of queues into which said packet is enqueueable.

51. The computer-readable medium of claim 45 wherein said instructions further cause said device to optionally discard packets having a discard check indicator indicating that said packet is discardable.

52. The computer-readable medium of claim 45 wherein said instructions further cause said device to:
maintain a discard probability for each of said plurality of queues; and
further communicate said discard probability to said upstream device.

53. The computer-readable medium of claim 52 wherein said discard probability is calculated according to the Random Early Detection scheme.

54. The computer-readable medium of claim 45 wherein said instructions further cause said device to:
determine an aggregate congestion level; and
communicate said aggregate congestion level to said upstream device.

55. The computer-readable medium of claim 45 wherein said congestion state information further includes congestion indication state information.
